(19) United States
(12) Patent Application Publication
(10) Pub. No.: US 2020/0215636 A1
(43) Pub. Date: Jul. 9, 2020

(54) METHOD AND SYSTEM FOR HOT-WIRE STRIP WIRE DEPOSITION AND CLADDING

(71) Applicant: LINCOLN GLOBAL, INC., Santa Fe Springs, CA (US)

(72) Inventors: Kyle G. Smith, Willoughby, OH (US); Steven R. Peters, Huntsburg, OH (US); Paul Edward Denney, Northborough, MA (US)

(73) Assignee: Lincoln Electronic, Inc.

(21) Appl. No.: 16/242,736

(22) Filed: Jan. 8, 2019

(51) Int. Cl. B23K 9/073; B23K 9/067; B23K 26/354

(52) U.S. Cl. CPC B23K 9/0731; B23K 9/0734; B23K 26/354; B23K 9/0676

(57) ABSTRACT

Methods and system of the present invention include hot-wire strip deposition system used in combination with a high heat source, where the system deposits a strip consumable into a molten puddle. During deposition the strip consumable is deposited at an angle relative to the workpiece surface and in some embodiments has a downforce applied to the consumable to maintain contact between the puddle and the consumable. The heating current for the consumable is turned off or greatly reduced when an arcing event is detected. In some embodiments the strip consumable can be curved to promote contact during the deposition process.

### TECHNICAL FIELD

Certain embodiments relate to strip wire overlaying applications as well as welding, joining, additive manufacturing and overlaying applications. More particularly, certain embodiments relate to systems and methods to utilize a hot-wire deposition process with either a laser or an arc welding process and suppression of an arc in strip wire deposition process.

### BACKGROUND

Recently, advances in hot-wire welding have been achieved. However, some of these processes and systems utilize traditional shaped wire consumables. While these consumables are adequate for many applications, they have limitations including deposition rate, and surface coverage. Further, when wire consumables are used for cladding or other surface coverage applications, in addition to taking an appreciable amount of time, the surface can require additional surface treatment such as machining/grinding to attain the desired surface conditions.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to clad, overlay, join or weld using a hot wire deposition process in which a strip consumable is used. Further embodiments of the systems and methods described herein are directed to an arc suppression technique in variable polarity hot-wire deposition operations.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary embodiment of a hot-wire and laser system;

FIG. 2 is a diagrammatical representation of an exemplary embodiment of a hot-wire and arc welding system;

FIG. 3 is a further diagrammatical representation of an exemplary embodiment of a hot-wire power supply and a system in which it is utilized;

FIG. 4 is a diagrammatical representation of an exemplary consumable deposition process;

FIGS. 5A to 5C are diagrammatical representations of exemplary heat source scanning paths for embodiments of the present invention;

FIG. 6 is a diagrammatical representation of an exemplary consumable deposition process of the present invention;

FIGS. 7A to 7C are diagrammatical representations of exemplary consumables that can be used with embodiments of the present invention;

FIGS. 8A and 8B are diagrammatical representations of an exemplary contact tube cross-sections; and

FIG. 9 is a diagrammatical representation of current, voltage and power waveforms in a hot-strip wire system where an arc event occurs.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

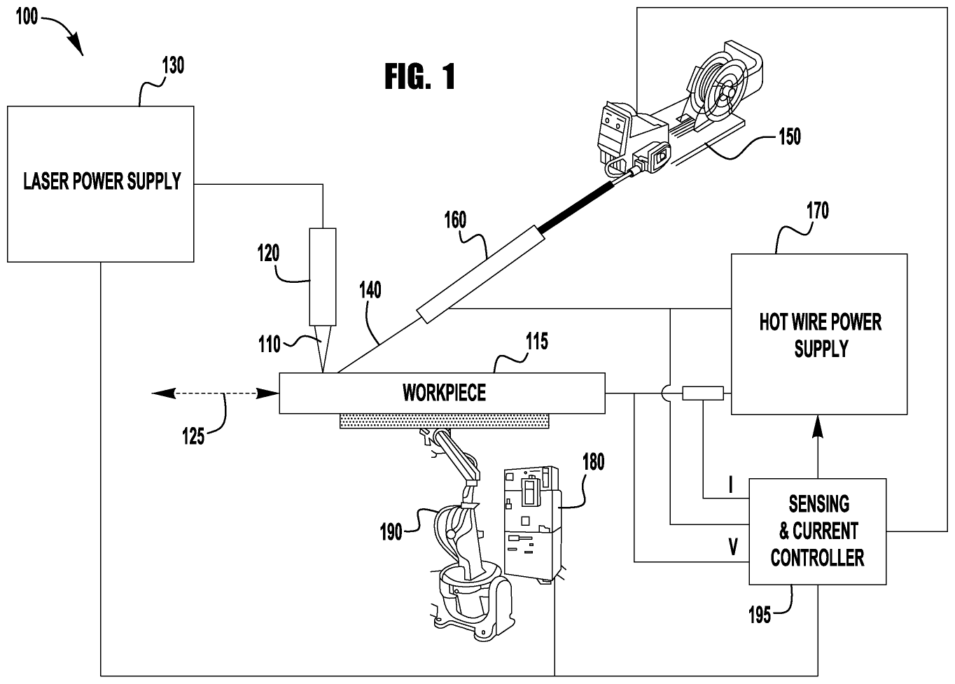

FIG. 1 illustrates a functional schematic block diagram of an exemplary embodiment of a combination consumable feeder and energy source system 100 for performing any of brazing, cladding, building up, filling, hard-facing overlaying, and joining/welding applications. The system 100 includes a laser subsystem capable of focusing a laser beam 110 onto a workpiece 115 to heat the workpiece 115. The laser subsystem is a high intensity energy source. The laser subsystem can be any type of high energy laser source, including but not limited to carbon dioxide, Nd:YAG, Yb-disk, YB-fiber, fiber delivered or direct diode laser systems. Further, other types of laser systems can be used if they have sufficient energy. Other embodiments of the system may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. The following specification will repeatedly refer to the laser system, beam and power supply, however, it should be understood that this reference is exemplary as any high intensity energy source may be used. For example, a high intensity energy source can provide at least 500 W/cm². The laser subsystem includes a laser device 120 and a laser power supply 130 operatively connected to each other. The laser power supply 130 provides power to operate the laser device 120.

The system 100 also includes a consumable feeder subsystem capable of providing at least one consumable 140 to make contact with the workpiece 115 in the vicinity of the laser beam 110. Of course, it is understood that by reference to the workpiece 115 herein, the molten puddle is considered part of the workpiece 115, thus reference to contact with the workpiece 115 includes contact with the puddle. The hot consumable feeder subsystem includes a consumable feeder 150, a contact tip 160, and a hot wire power supply 170. During operation, the consumable 140 is resistance-heated by electrical current from the hot wire power supply 170 which is operatively connected between the contact tip 160 and the workpiece 115. In accordance with an embodiment of the present invention, the hot wire welding power supply 170 is a pulsed direct current (DC) power supply, although alternating current (AC) or other types of power supplies are possible as well. The consumable 140 is fed from the feeder 150 through the contact tube 160 toward the workpiece 115 and extends beyond the tube 160. The extension portion of the consumable 140 is resistance-heated such that the extension portion approaches or reaches the melting point before contacting a weld puddle on the workpiece. The laser beam 110 serves to melt some of the base metal of the workpiece 115 to form a weld puddle and also to melt the consumable 140 onto the workpiece 115. The power supply 170 provides a large portion of the energy needed to resistance-melt the consumable 140, such that the consumable melts in the puddle. The feeder subsystem may be capable of simultaneously providing one or more consumables, in accordance with certain other embodiments of the present invention. For example, a first consumable may be used for hard-facing and/or providing corrosion resistance to the workpiece, and a second wire may be used to add structure to the workpiece.

The system 100 further includes a motion control subsystem capable of moving the laser beam 110 (energy source) and the resistive consumable 140 in a same direction 125 along the workpiece 115 (at least in a relative sense) such that the laser beam 110 and the resistive consumable 140 remain in a fixed relation to each other. According to various embodiments, the relative motion between the workpiece 115 and the laser/consumable combination may be achieved by actually moving the workpiece 115 or by moving the laser device 120 and the feeder subsystem. In FIG. 1, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the laser beam 110 and the consumable 140 effectively travel along the workpiece 115. In accordance with an alternative embodiment of the present invention, the laser device 110 and the contact tube 160 may be integrated into a single head. The head may be moved along the workpiece 115 via a motion control subsystem operatively connected to the head.

In general, there are several methods that a high intensity energy source/hot wire may be moved relative to a workpiece. If the workpiece is round, for example, the high intensity energy source/consumable may be stationary and the workpiece may be rotated under the high intensity energy source/hot wire. Alternatively, a robot arm or linear tractor may move parallel to the round workpiece and, as the workpiece is rotated, the high intensity energy source/consumable may move continuously or index once per revolution to, for example, overlay the surface of the round workpiece. If the workpiece is flat or at least not round, the workpiece may be moved under the high intensity energy source/consumable as shown if FIG. 1. However, a robot arm or linear tractor or even a beam-mounted carriage may be used to move a high intensity energy source/consumable head relative to the workpiece.

The system 100 further includes a sensing and current control subsystem 195 which is operatively connected to the workpiece 115 and the contact tube 160 (i.e., effectively connected to the output of the hot wire power supply 170) and is capable of measuring a potential difference (i.e., a voltage V) between and a current (I) through the workpiece 115 and the consumable 140. The sensing and current control subsystem 195 may further be capable of calculating a resistance value (R=V/I) and/or a power value (P=V*I) from the measured voltage and current. In general, when the consumable 140 is in contact with the workpiece 115, the potential difference between the consumable 140 and the workpiece 115 is zero volts or very nearly zero volts. As a result, the sensing and current control subsystem 195 is capable of sensing when the resistive consumable 140 is in contact with the workpiece 115 and is operatively connected to the hot wire power supply 170 to be further capable of controlling the flow of current through the resistive consumable 140 in response to the sensing, as is described in more detail later herein. In accordance with another embodiment of the present invention, the sensing and current controller 195 may be an integral part of the hot wire power supply 170.

In accordance with an embodiment of the present invention, the motion controller 180 may further be operatively connected to the laser power supply 130 and/or the sensing and current controller 195. In this manner, the motion controller 180 and the laser power supply 130 may communicate with each other such that the laser power supply 130 knows when the workpiece 115 is moving and such that the motion controller 180 knows if the laser device 120 is active. Similarly, in this manner, the motion controller 180 and the sensing and current controller 195 may communicate with each other such that the sensing and current controller 195 knows when the workpiece 115 is moving and such that the motion controller 180 knows if the feeder subsystem is active. Such communications may be used to coordinate activities between the various subsystems of the system 100.

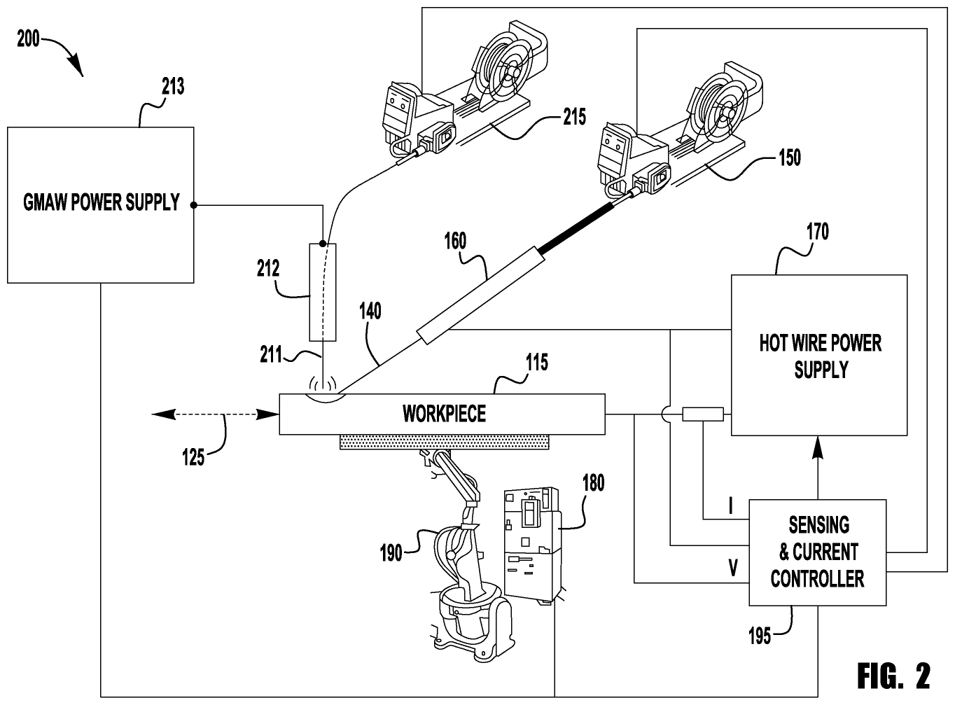

As described above, the high intensity energy source can be any number of energy sources, including welding power sources. An exemplary embodiment of this is shown in FIG. 2, which shows a system 200 similar to the system 100 shown in FIG. 1. Many of the components of the system 200 are similar to the components in the system 100, and as such their operation and utilization will not be discussed again in detail. However, in the system 200 the laser system is replaced with an arc welding system, such as a GMAW system. The GMAW system includes a power supply 213, a wire feeder 215 and a torch 212. A welding electrode 211 is delivered to a molten puddle via the wire feeder 215 and the torch 212. The operation of a GMAW welding system of the type described herein is well known and need not be described in detail herein. It should be noted that although a GMAW system is shown and discussed regarding depicted exemplary embodiments, exemplary embodiments of the present invention can also be used with GTAW, FCAW, MCAW, and SAW systems, cladding systems, brazing systems, and combinations of these systems, etc., including those systems that use an arc to aid in the transfer of a consumable to a molten puddle on a workpiece. Not shown in FIG. 2 is a shielding gas system or sub arc flux system which can be used in accordance with known methods.

Like the laser systems described above, the arc generation systems (that can be used as the high intensity energy source) are used to create the molten puddle to which the consumable 140 is added using systems and embodiments as described in detail above. However, with the arc generation systems, as is known, an additional consumable 211 can also added to the puddle. This additional consumable adds to the already increased deposition performance provided by the hot wire process described herein. This performance will be discussed in more detail below. However, in other embodiments, such as with a GTAW system and additional consumable need not be added to the puddle. In such systems it is possible to simply use the arc generated by the electrode without the addition of an additional consumable.

Further, as is generally known arc generation systems, such as GMAW use high levels of current to generate an arc between the advancing consumable and the molten puddle on the workpiece. Similarly, GTAW systems use high current levels to generate an arc between an electrode and the workpiece, into which a consumable is added. As is generally known, many different current waveforms can be utilized for a GTAW or GMAW welding operation, such as constant current, pulse current, etc. However, during operation of the system 200 the current generated by the power supply 213 can interfere with the current generated by the power supply 170 which is used to heat the wire 140. Because the consumable 140 is proximate to the arc generated by the power supply 213 (because they are each directed to the same molten puddle, similar to that described above) the respective currents can interfere with each other. Specifically, each of the currents generates a magnetic field and those fields can interfere with each other and adversely affect their operation. For example, the magnetic fields generated by the heating current can interfere with the stability of the arc generated by the power supply 213. That is, without proper control and synchronization between the respective currents the competing magnetic fields can destabilize the arc and thus destabilize the process. Therefore, exemplary embodiments utilize current synchronization between the power supplies 213 and 170 to ensure stable operation, which will be discussed further below.

As stated above, magnetic fields induced by the respective currents can interfere with each other and thus embodiments of the present invention synchronize the respective currents. Synchronization can be achieved via various methods. For example, the sensing and current controller 195 can be used to control the operation of the power supplies 213 and 170 to synchronize the currents. Alternatively, a master-slave relationship can also be utilized where one of the power supplies is used to control the output of the other. The control of the relative currents can be accomplished by a number of methodologies including the use of state tables or algorithms that control the power supplies such that their output currents are synchronized for a stable operation. This will be discussed further below. For example, a dual-state based system and devices similar to that described in US Patent Publication No. 2010/0096373 can be utilized. US Patent Publication No. 2010/0096373, published on Apr. 22, 2010, is incorporated herein by reference in its entirety.

A more detailed discussion of the structure, use, control, operation and function of the systems 100 and 200 is set forth in at least the U.S. patent application Ser. Nos. 13/212,025 and 12/352,667 which are assigned to the same owner of the present application, and which are fully incorporated herein by reference in their entirety as they relate to the systems described and discussed herein and alternative embodiments discussed therein, which are not repeated here for efficiency and clarity.

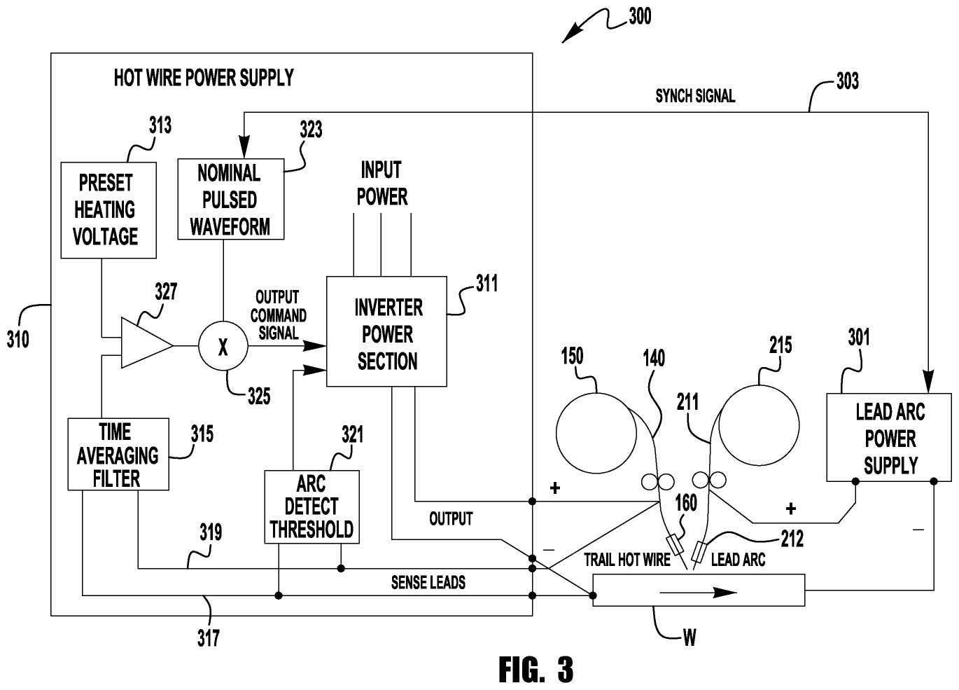

FIG. 3 depicts a schematic representation of another exemplary embodiments of a system 300 of the present invention. Like the system 200, the system 300 utilizes a combined hot-wire and arc welding process. The function and operation of the system 300 is similar to that of the system 200, and as such similar functionality will not be repeated. As shown, the system 300 comprises a leading arc welding power supply 301 which leads the trailing hot wire 140. The power supply 301 is shown as a GMAW type power supply, but embodiments are not limited to this as a GTAW type power supply can also be utilized. The welding power supply 301 can be of any known construction. Also depicted is a hot-wire power supply 310 (which can be the same as that shown in FIGS. 1 and 2) along with some of the components therein. As explained above, it may be desirable to synchronize the current waveforms output from each of the power supplies 301 and 310. As such a synchronization signal 303 can be utilized to ensure that the operation of the power supplies are synchronized, which will be further described below.

The hot-wire power supply 310 comprises an inverter power section 311 which receives input power (which can be either AC or DC) and converts the input power to an output power that is used to heat the consumable 140 so that it can be deposited into a puddle on the workpiece W. The inverter power section 311 can be constructed as any known inverter type power supply which is used for welding, cutting or hot-wire power supplies. The power supply also contains a preset heating voltage circuit 313 which utilizes input data related to the process to set a preset heating voltage for the output signal of the power supply 310 so that the wire 140 is maintained at a desired temperature so that it is properly deposited onto the workpiece W. For example, the preset heating voltage circuit 313 can utilize settings such as consumable size, consumable type and consumable feed speed to set the preset heating voltage to be maintained during the process. During operation the output heating signal is maintained such that the average voltage of the output signal, over a predetermined duration of time or number of cycles, is maintained at the preset heating voltage level. In some embodiments, the preset heating voltage level is in the range of 2 to 9 volts. Further, in exemplary embodiments of the present invention, the consumable feed speed of the wire 140 can affect the optimal preset heating voltage level, such that when the consumable feed speed is low (at or below 200 in/min) the preset heating voltage level is in the range of 2 to 4 volts, whereas if the feed speed is high (above 200 in/min) the preset heating voltage level is in the range of 5 to 9 volts. Further, in some exemplary embodiments, when the current is low (at or below 150 amps) the preset heating voltage level is in the range of 2 to 4 volts, whereas if the current is high (above 150 amps) the preset heating voltage level is in the range of 4 to 7 volts. Thus, during operation the power supply 310 maintains the average voltage between the consumable 140 and the workpiece W at the preset heating voltage level for the given operation. In other exemplary embodiments, the preset heating voltage circuit 313 can set an average voltage range, where the average voltage is maintained within the preset range. By maintaining the detected average voltage at the preset heating voltage level or within the preset heating voltage range, the power supply 310 provides a heating signal which heats the consumable 140 as desired, but avoiding the creation of an arc. In exemplary embodiments of the present invention, average voltage is measured over a predetermined period of time, such that a running average is determined during the process. The power supply utilizes a time averaging filter circuit 315 which senses the output voltage through the sense leads 317 and 319 and conducts the voltage averaging calculations described above. The determined average voltage is then compared to the preset heating voltage as shown in FIG. 3. In other exemplary embodiments, the power supply can maintain a desired power level, a desired slope of voltage or current. As understood by those of skill in the art, the load is resistive and the resistive value of a deposition process will depend on factors such as the wire type, wire size, wire feed speed and stick out. Thus, other control parameters or thresholds can be used by the power supply to maintain stability of a deposition operation without departure from the scope of the present invention. That is, for example, a set output power level can be maintained to provide a desired operational control level.

Of course, in other exemplary embodiments the power supply 310 can use current and/or power preset thresholds to control the output signal of the power supply. The operation of such systems would be similar to the voltage based control described above. Further, other examples can monitor the resistance through the consumable and/or dr/dt and compare the determined resistance, or resistance changes compared a desired or set threshold.

The power supply 310 also contains an arc detect threshold circuit 321 which compares the detected output voltage—through the sense leads 319 and 317—and compares the detected output voltage with an arc detection voltage level to determine an arcing event has, or will occur, between the consumable 140 and the workpiece W. If the detected voltage exceeds the arc detection voltage level the circuit 321 outputs a signal to the inverter power section 311 (or a controller device) which causes the power section 311 to shut off the output power to distinguish the arc, or otherwise prevent its creation. In some exemplary embodiments the arc detection voltage level is in the range of 10 to 20 volts. In other exemplary embodiments the arc detection voltage level is in the range of 12 to 19 volts. In further exemplary embodiments, the arc detection voltage level is determined based on the preset heating voltage level and/or the wire feed speed. For example, in some exemplary embodiments, the arc detection voltage level is in the range of 2 to 5 times the preset heating voltage level. In other exemplary embodiments, the anode and cathode voltage level for any shielding gas being used can affect the preset heating voltage level. In other exemplary embodiments, the anode and cathode voltage level for any shielding gas being used can affect the preset heating voltage level. In some exemplary applications the arc detection voltage will be in the range of 7 to 10 volts, while in other embodiments it will be in the range of 14 to 19 volts. In exemplary embodiments of the present invention, the arc detection voltage will be in the range of 5 to 8 volts higher than the preset heating voltage level. Of course, other arc detection voltage levels can be used as needed for a desired system performance. Further, in other exemplary embodiments the arc detection circuit can use other feedback parameters such as current and/or power or any combination of voltage, current and power to detect an arc detection event. Once the arc detection event is detected the power supply is then instructed to turn off or significantly lower the current to either prevent the creation of an arc or extinguish and arc. That is, an arc detection event can be the detection of an actual arc or can be the detection of an imminent arc. Either control methodology can be used as desired for a given operation. Thus, in exemplary embodiments, feedback of the consumable heating signal is used by the power supply controller and compared to a set threshold value (which can be for voltage, current or power) and is used to control the heat signal as described herein.

The power supply 310 also includes a nominal pulsed waveform circuit 323 which generates the waveform to be used by the inverter power section 311 to output the desired heating waveform to the wire 140 and workpiece W. As shown the nominal pulsed waveform circuit 323 is coupled to the arc welding power supply 301 via the synchronization signal 303 so that the output waveforms from each of the respective power supplies are synchronized as described herein.

As shown, the nominal pulsed waveform circuit 323 synchronizes its output signal with the arc welding power supply 301 and outputs a generated heating waveform to a multiplier which also receives an error signal from the comparator 327 as shown. The error signal allows for adjustment of the output command signal to the inverter power section 311 to maintain the desired average voltage as described above.

It should be noted that the above described circuits and basic functionality is similar to that utilized in welding and cutting power supplies and as such the detailed construction of these circuits need not be described in detail herein. Further, it is also noted that some or all of the above functionality can be accomplished via a single controller within the power supply 310.

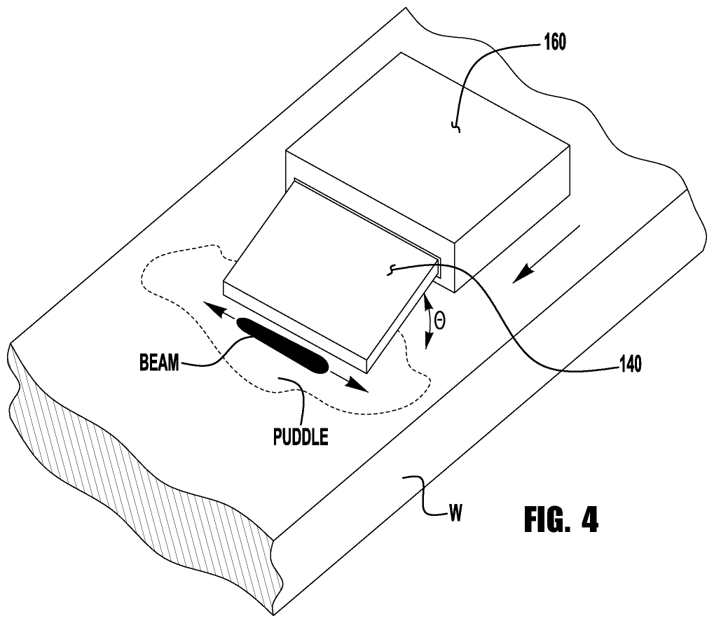

Turning now to FIG. 4, which depicts an exemplary embodiment of the deposition of the consumable 140 discussed above. As shown, the consumable 140, which is, the shape of a strip, is deposited into the puddle on the surface of a workpiece W. the strip is deposited at an angle a to the surface of the work piece. In exemplary embodiments, the angle is in the range of 5 to 60 degrees relative to the surface of the workpiece. In further exemplary embodiments, the angle is in the range of 15 to 45 degrees. The angle should be chosen to allow the desired deposition characteristics on the surface of the work piece. In some embodiments a shallower (smaller) angle a is desirable, for example when it is desired to have limited admixture with the workpiece material, whereas steeper angles may be desired when more admixture is desired. Also shown in FIG. 4, to the extent a laser is used as the heat source, the beam impacts the puddle near where the strip 140 enters the puddle. While the embodiment in FIG. 4 shows the beam being positioned such that it is near, but not contacting the consumable, but the beam is positioned so as to maintain the desired puddle for the consumable. However, in other embodiments, the beam can overlap at least a portion of the consumable 140.

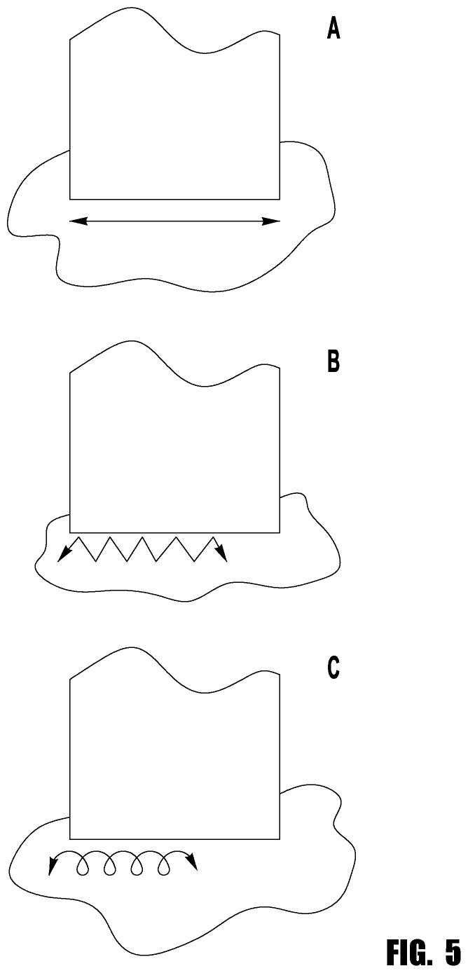

In applications using a laser as the heat source, the shape of the laser beam can vary. For example, in some applications the beam shape can be elongated, such as rectangular, and can have a width which is larger than then width of the consumable/strip. For example, in some embodiments the beam width can be larger than the width of the consumable by at least 0.5 to 3 mm. In some embodiments the width can be 1 to 2 mm larger. In other embodiments, the beam cross-section (at the workpiece surface) can be smaller than the width of the consumable 140, but the beam can be rasterized at a rate which provides sufficient heating to create the desired puddle. For example, the beam can have a circular, oval, square or rectangular shape (at the surface) and the beam can be moved across the workpiece to create a beam impact zone that is sufficiently wide to create the desired puddle width and provide the desired heat input. Exemplary beam paths are shown in FIGS. 5A to 5C. FIG. 5A depicts a linear path, which is perpendicular to the travel direction of the consumable 140. FIG. 5B shows a saw tooth path and FIG. 5C depicts a circular path near the consumable 140. Of course, other beam paths can be used when the beam has a width which is less than the width of the consumable. The beam shape, beam speed and path should be chosen to maintain a molten puddle for deposition of the consumable on the surface of the workpiece. Thus, when using a laser beam as a heat source for the deposition process, as opposed to other types of heat sources, the physical laser need not be moved during the process, as the beam can be moved and have the shape changed during the process without moving the laser beam source. That is, it is well known that optics can be used to change beam shape and positioning during the deposition process. However, when using a plasma based heat source the heat source will need to be moved as the shape and movement of the plasma cannot easily be manipulated without moving the source.

Further, while not shown, other exemplary embodiments can use more than one beam impacting the workpiece surface to create the puddle. For example, two or more beams can be used to create the desired beam impact zone on the workpiece to create the desired puddle width. In some embodiments, the two or more beams can come from the same laser source, or can come from different laser sources. In such embodiments, the movement of the respective beams can be synchronized and coordinated using known laser optic technologies and methodologies. In some exemplary embodiments, one beam can impact the workpiece to create the puddle, and at least one other beam can impact at least a portion of the consumable 140 to aid in melting the consumable into the puddle as desired.

In the embodiment shown in FIG. 4, the beam is placed in front of the consumable 140—in the travel direction. In this embodiment, the leading beam impact point creates the puddle in advance of the beam. In other embodiments (discussed further below) the beam can be placed in a trailing position relative to the consumable 140 entering the puddle. In further embodiments, which use multiple beams, a beam can be placed in a leading position and another can be placed in a trailing position. Further, in some embodiments, the consumable 140 is angled as shown in FIG. 4 where the consumable is angled into the travel direction. However, in other exemplary embodiments, the consumable 140 is angled away from the travel direction (in this embodiment the travel direction is opposite of what is shown in FIG. 4).

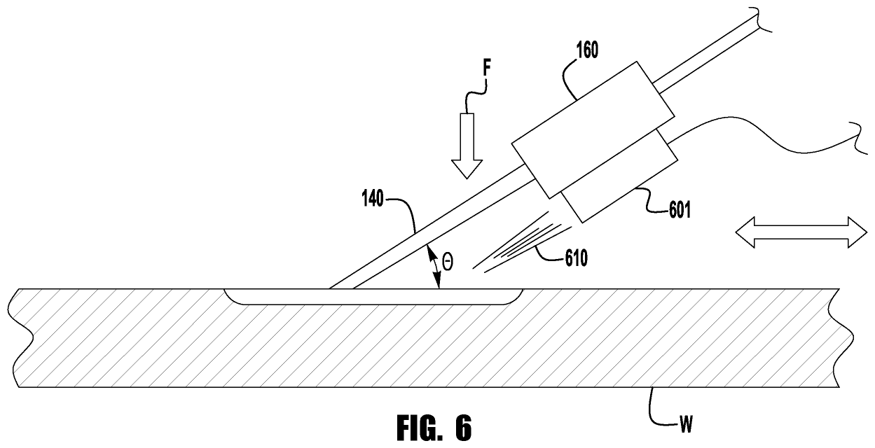

FIG. 6 shows a side view of an exemplary consumable deposition process, having a laser emitting device 601 coupled to the contact tube 160. In this embodiment the emitting device 601 directs a beam 610 to the puddle below the consumable 140, as shown. This configuration can be used when the beam 610 is placed in the leading or trailing position relative to the travel direction of the consumable 140. This laser source 601 (which can be a dedicated laser or optics used to direct a beam from a remote laser source) can be coupled to and controlled by the laser power supply 130 and/or the system controller 195 as needed.

Additionally, as shown in FIG. 6, in exemplary embodiments the positioning of the contact tube 160 relative to the surface of the work-piece W and stick-out length of the consumable 140 can be selected so as to provide a down force F between the consumable 140 and the workpiece W. That is, in known wire based systems, it is desirable to have no contact or resistive forces between the workpiece and the wire consumable. However, in embodiments of the present invention, which use a strip consumable, a downforce is provided which pushes the consumable 140 against the surface of the workpiece to ensure that the consumable is sufficiently joined with the workpiece and the puddle. In exemplary embodiments using a downforce F the consumable 140 is moved is dragged over the surface of the workpiece (i.e., in FIG. 6 the consumable 140 is moved to the right—dragging the consumable 140). This aids in the ensuring an appropriate application of the consumable 140 on the surface of the workpiece W, particularly in cladding and hard-facing applications. The downforce F applied between the consumable 140 and the surface should be appropriate for the operation and consumable size. In some exemplary embodiments the down force is in the range of 5 to 25 lbf. Of course, other embodiments can use different downforces to optimize the performance of the deposition process. The downforce can be applied by any known methods and structure. For example, the system can place the contact tube 160 at a fixed height above the work surface and the controller can manage the stick out of the consumable such that downforce is provided. That is the stick out can be long enough that contact is made with the work surface to apply a bending force on the consumable. Similarly, the height of the contact tube 160 can be controllable and positionable, either manually or via the system controller so as to apply the desired downforce for a given stick-out length. In some embodiments, the contact tube can be coupled to a force measurement device (not shown). Such devices are well known and need not be discussed in detail herein. Information from a force measurement device can be employed by a user and/or the controller of the system to maintain a desired force between the consumable and the work surface. The controller can use a desired set point to maintain a desired force setting, and can change the position of the contact tube, the heating waveform current and/or power, the feed speed of the consumable, or any other parameters to obtain and maintain a desired force between the consumable and the work surface. In some exemplary embodiments, when an arc event is detected (as described herein) the downforce F can be reduced or turned off by the controller. This can be accomplished by moving the contact tip 160 to remove or reduce the downforce F. It is noted that in some embodiments the consumable 140 still maintains contact with the puddle whereas the downforce is removed or is minimal. For example, in embodiments the contact can be maintained with the puddle without a downforce being present as there is no contact between the consumable 140 and the non-molten surface of the workpiece. Further, in additional exemplary embodiments the creation of an arc event can be a result of the loss off downforce and/or contact between the puddle and the consumable. To restart the deposition process and create a needed downforce the deposition head and/or the workpiece can be moved to reinitiate the contact and downforce between consumable and workpiece. In such embodiments, the laser or other heat source can be moved or have its focus changed to maintain the desired energy density at the surface of the workpiece. For example, if the head is moved closer to the surface to make contact the focus of a laser (if used) can be changed to ensure that the appropriate energy is directed to the surface for the puddle. In some embodiments, without the focus change the energy at the surface can be too high.

In additional exemplary embodiments, the deposition system can include a tracking system (not shown), such as an optical tracking system that can track the consumable and/or the puddle to be used to control the laser optics relative to the workpiece and/or puddle. This tracking system can be used to ensure that the beam is located at the desired position relative to the strip during the deposition process. Such tracking systems and control methodology used to control the laser optics, etc. are well known and need not be described in detail herein.

Turning now to the consumable 140, in exemplary embodiments the consumable can be any strip-type consumable known or used in cladding and/or hard-facing applications. However, other embodiments are not limited to using a traditional strip consumable, but can use other shapes, which are not circular in cross-section. The consumable can be made from any known or desirable materials for strip-type consumables, or have any desired composition for a given operation. Further, in applications in which an arc is not used as the heat source, other non-typical materials can be used in the consumable, including for example, diamonds, tungsten carbide, etc. In many applications the consumable can have a simple rectangular cross-section and have a thickness in the range of 0.1 to 4 mm and a width in the range of 1 to 120 mm depending on the operation and the desired deposition process. Of course, other dimensions can be used based on the given parameters of an operation.

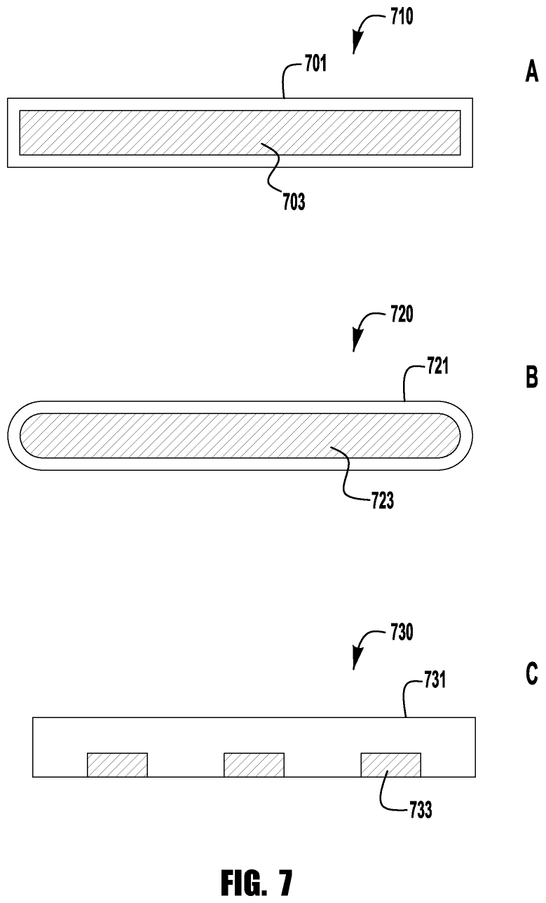

FIGS. 7A through 7C depict other exemplary embodiments of a consumable that can be used with embodiments of the present invention. As shown, in addition to a traditional solid consumable, a consumable with a sheath and core can be used. Each of FIGS. 7A and 7B depict a traditional sheath/core construction. FIG. 7A depicts a consumable 710 with a rectangular cross-section having a metal sheath 701 (of any desired composition) and a core 703 of any desired composition. The core 703 can be a solid core or can be a granular or flux core as desired. The core 703 can contain any desired composition or components that are to be deposited into the puddle and/or on the surface of the workpiece. The core can be used to deliver compositions or materials not easily made into sheath material, or materials that are to be deposited without being directly exposed to a high energy heat source. Each of the consumables in FIGS. 7A and 7B can be made via known methods and procedures to create cored and sheathed consumables. FIG. 7C depicts a further exemplary embodiment of a consumable, where the consumable comprises first portion 731 and a second portion 733. The portion 731 can be made from a first material, such as a solid material that has the same characteristics as a sheath, and the portion(s) 733 can be a different solid material or can be a flux type material as described above. The consumable 730 can have a single channel of the material 733 or can have multiple channels as shown. Embodiments such as the type shown in FIG. 7C can be used to deliver the desired composition and materials in a consumable configuration that is easily manufactured and protects certain materials from a high energy heat source. Of course, the configuration shown is only exemplary and any other asymmetric cross-section can be used as desired for a given operation.

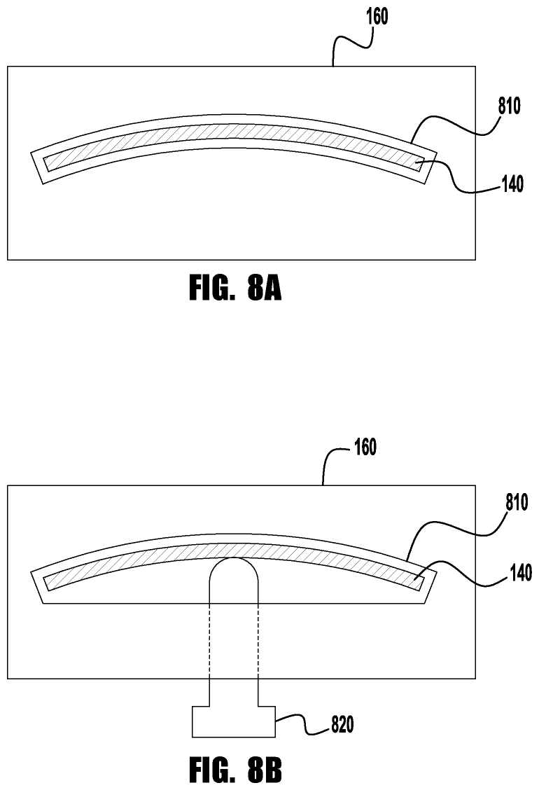

FIGS. 8A and 8B depict an exemplary cross-section of a contact tube 160 of embodiments of the present invention. In some embodiments, the contact tube 160 can be configured similar to known strip consumable contact tubes that are capable of delivering a strip consumable to a surface. However, as shown in FIGS. 8A and 8B a contact tube 160 can also have a curved orifice 810 which imparts a curvature on the consumable 140 prior to its deposition. As strip consumables get wider, during some deposition operations, the consumables can tend to curve away from the surface of the workpiece at the ends, particularly during high heat operations, or operations on a surface with surface defects, or a curved surface. To deal with this, some embodiments use a curved orifice which shapes the consumable with a curvature prior to deposition. In FIG. 8A the orifice is fixed to apply a fixed curvature to the consumable 140. In exemplary embodiments, the applied curvature is such that it imparts only an elastic bend in the consumable 140, and is not capable of permanently deforming the consumable. FIG. 8B is another similar embodiment, except that the contact tube 160 comprises a positionable curvature device 820. The curvature device is positionable to allow for the creation of different curvatures based on the positioning of the device 820. For example, the device 820 can be a set screw, or similar component, that is threaded into the tube 160. The positioning of the device 820 can be changed so that the amount of deflection for the curvature can be changed for a give operation. For example, for a first operation the device 820 can be positioned to create a very shallow or subtle curvature, whereas in other operations the device 820 can be repositioned to create a more extreme curvature. Such an embodiment increases the flexibility and usability of the contact tube 160. Further, in such an embodiment, the orifice 810 is configured to allow for the use of different curvatures within the same orifice. Further, although not shown, additional devices similar to device 820 can be used at other locations to create the desired consumable curvature as needed. For example, downward facing devices can used on the respective sides of the orifice to provide a desired curvature. The devices can be positionable via manual manipulation of via the controller of the system.

In exemplary embodiments of the present invention, the constant current, constant voltage or pulse type waveforms can be used to deposition the consumables. Further, in some exemplary embodiments an AC current or variable polarity can be used. In some embodiments the current levels used during the deposition process can be as high as 600 to 700 amps. Further, as described above, an arc suppression control methodology is used to prevent the formation of an arc during the deposition of the process or quickly extinguish any created arc. Any known arc suppression control methodology can be used. For example, in some embodiments a dv/dt arc suppression control methodology can be used, where the change in voltage is monitored to determine if the creation of an arc has occurred or is imminent. When the detection of an arc event (either an actual arc or impending arc) occurs, the system can rapidly reduce the current (for example to a level in the range of 30 to 100 amps), or can turning the heat current off. In other exemplary embodiments a change in resistance can be used as the control methodology—dr/dt. In such embodiments, an increase in resistance can indicate a separation between the consumable and the puddle/workpiece and thus a potential arc event. Thus, if the resistance detected, or the rate of change of the circuit resistance exceeds a determined threshold, the heating current can be decreased or turned off, depending on the control methodology used. Again, in other exemplary embodiments the power supply of the deposition system can use a desired power set point to control the current/voltage for the deposition process, and in other embodiments can use a desired voltage or current slope to control the power supply output. In further embodiments, the power supply can use a synchronized system or AC system to minimize arc interference or arc creation.

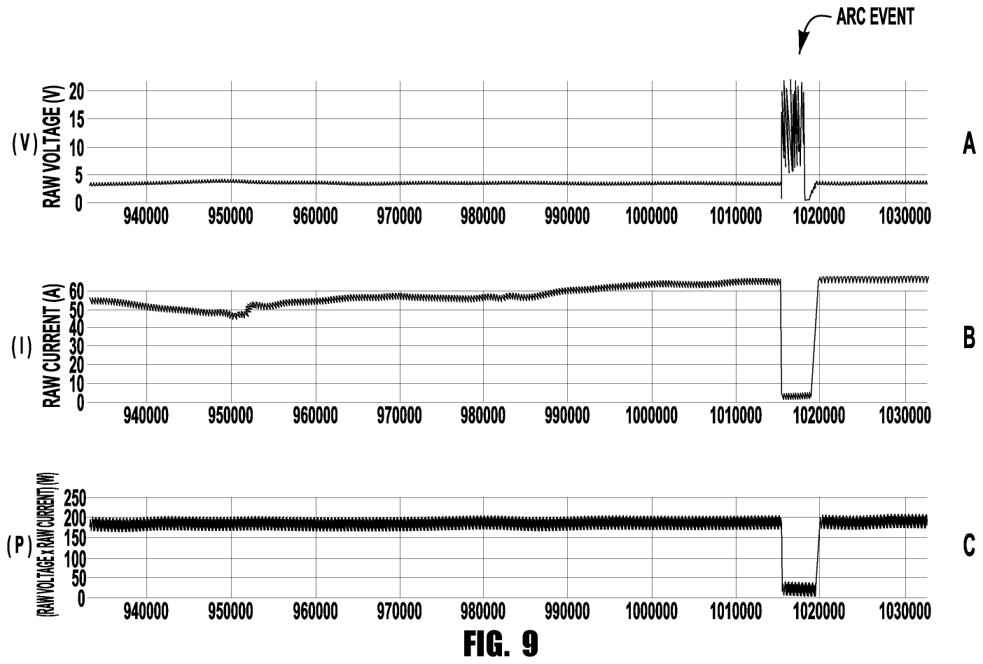

Turning now to FIG. 9, this figure depicts each of an exemplary voltage (A), current (B) and power (C) output of the power supply during a strip deposition process. In this exemplary embodiment, the power supply used an output power based control methodology where the output power is maintained a desired level. As discussed herein, the desired output level (whether it be power, voltage or current slope, voltage, current, resistance, etc.) can be determined by various process input parameters and use a look up table, or the like to provide the desired output set point. The parameters can include, but are not limited to, consumable type, consumable size, feed speed, stick out, travel speed, process type (e.g., cladding, additive, etc.). As shown in this example, the power output is maintained until an arc event is detected. The arc event can be detected by any of the control methods discussed herein. As shown, because of the creation of an arc the voltage increases which causes a brief spike in output power until the output current is reduced or shut off. Upon detection of the arc event (which can be the generation of an arc or an event immediately prior to the creation of an arc, the current is shut off or greatly reduced to extinguish the arc. In exemplary embodiments the current is kept low or off for a period of time and is then ramped back up to provide the desired output current/power. The duration of the low/no current period can be predetermined based on factors such as feed rate, stick out, travel speed, etc. Further, in other embodiments the current can be increased upon detection of contact between the consumable and the puddle/surface of the work piece. Of course, the waveforms shown in FIG. 9 are exemplary and other waveforms, such as alternating current, etc. can be used to provide the desired deposition performance.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the present application.

We claim:

1. A method of depositing a strip consumable, comprising:
creating a puddle on a workpiece with at least one high intensity energy source;
determining an arc event threshold value for a strip consumable heating signal;
heating a strip consumable with said strip consumable heating signal output from a power source to a temperature such that said strip consumable melts in said puddle when said strip consumable is in contact with said weld puddle;
directing said strip consumable to said puddle such that said strip consumable maintains contact with said weld puddle during a deposition operation;
providing a downforce on said strip consumable to maintain said strip consumable in contact with said puddle;
monitoring a feedback of said strip consumable heating signal;
shutting off said strip consumable heating signal when said threshold value is reached by said strip consumable heating signal such that no arc is generated between said strip consumable and said weld puddle; and
turning on said strip consumable heating signal to continue heating said strip consumable.

2. The method of claim 1, wherein said strip consumable heating signal has a preset heating voltage in the range of 5 to 9 volts.

3. The method of claim 1, wherein said strip consumable heating signal has a preset heating voltage in the range of 4 to 7 volts.

4. The method of claim 1, wherein said power source monitors a power of said heating signal and controls said output of said heating signal based on said power.

5. The method of claim 1, wherein said arc event threshold value is an output voltage.

6. The method of claim 5, wherein said output voltage is in the range of 10 to 20 volts.

7. The method of claim 1, wherein said strip consumable is oriented at an angle of 5 to 60 degrees relative to a surface of said workpiece.

8. The method of claim 1, wherein said energy source is a laser emitting a laser beam having a width in the range of 0.5 to 3 mm wider than said strip consumable.

9. The method of claim 1, wherein said downforce is in the range of 0.5 to 25 lbf.

10. The method of claim 1, further comprising providing a curvature to said strip consumable prior to said consumable contacting said puddle.

11. A system for depositing a strip consumable, comprising:
a high intensity energy source which creates a puddle on a workpiece;
a strip consumable delivery device which delivers a strip consumable to said puddle during a deposition operation of said strip consumable and maintains contact between said puddle and said strip consumable; and
a power supply which outputs a strip consumable heating signal to said strip consumable, where said strip consumable heating signal has a power level to melt said strip consumable in said puddle when said strip consumable is in contact with said puddle, where said power supply uses an arc event threshold value for said strip consumable heating signal to control an output of said strip consumable heating signal;
wherein said strip consumable delivery device maintains a downforce on said strip consumable to maintain said strip consumable in contact with said puddle;
wherein said power supply shuts off said strip consumable heating signal when said arc event threshold value is reached and outputs said strip consumable heating signal after said strip consumable heating signal is turned off.

12. The system of claim 11, wherein said strip consumable heating signal has a preset heating voltage in the range of 5 to 9 volts.

13. The system of claim 11, wherein said strip consumable heating signal has a preset heating voltage in the range of 4 to 7 volts.

14. The system of claim 11, wherein said power source monitors a power of said heating signal and controls said output of said heating signal based on said power.

15. The system of claim 11, wherein said arc event threshold value is an output voltage.

16. The system of claim 15, wherein said output voltage is in the range of 10 to 20 volts.

17. The system of claim 11, wherein said strip consumable delivery device is configured to orient said strip consumable at an angle of 5 to 60 degrees relative to a surface of said workpiece.

18. The system of claim 11, wherein said energy source is a laser emitting a laser beam having a width in the range of 0.5 to 3 mm wider than said strip consumable.

19. The system of claim 11, wherein said downforce is in the range of 0.5 to 25 lbf.

20. The system of claim 11, further comprising a curvature device which adds a curvature to said strip consumable prior to said consumable contacting said puddle.
